(19) United States
(12) Patent Application Publication
(10) Pub. No.: US 2024/0012302 A1
(43) Pub. Date: Jan. 11, 2024

(54) LIGHT ADJUSTMENT DEVICE

(71) Applicant: Japan Display Inc., Tokyo (JP)

(72) Inventors: Masato YOSHIDA, Tokyo (JP); Hirofumi OHIRA, Tokyo (JP)

(73) Assignee: Japan Display Inc., Tokyo (JP)

(21) Appl. No.: 18/341,783

(22) Filed: Jun. 27, 2023

(30) Foreign Application Priority Data
Jul. 7, 2022 (JP) 2022-109596

(51) Int. Cl. F21V 17/00

(52) U.S. Cl. CPC F21V 17/005; F21V 14/003

(57) ABSTRACT

A light adjustment device includes a panel unit including a plurality of light adjustment panels stacked in a first direction, each light adjustment panel including a first substrate, a second substrate, and a plurality of alignment marks provided at at least one of the first substrate and the second substrate.

### CROSS-REFERENCE TO RELATED APPLICATION

This application claims the benefit of priority from Japanese Patent Application No. 2022-109596 filed on Jul. 7, 2022, the entire contents of which are incorporated herein by reference.

### BACKGROUND

### 1. Technical Field

The present disclosure relates to a light adjustment device.

### 2. Description of the Related Art

A light adjustment device in which a plurality of panels are stacked is publicly known (refer to Japanese Patent Application Laid-open Publication No. 2019-70734 (JP-A-2019-70734), for example). In the light adjustment device, a light adjustment panel for p-wave polarized light and a light adjustment panel for s-wave polarized light obtained by rotating the light adjustment panel for p-wave polarized light by 90° are alternately stacked in some cases, and it is required to reduce the positional shift between the light adjustment panels in such a case. In JP-A-2019-70734, each panel is provided with a rectangular alignment mark having the same size. The panels are sequentially stacked by placing each two panels over each other while adjusting the positions of the panels so that the alignment marks coincide with each other. The alignment marks of all panels have rectangular shapes of the same size.

According to JP-A-2019-70734, it can be checked that all panels are disposed at appropriate positions in a case in which the alignment marks overlap each other and appear as one rectangle when the light adjustment device is viewed from top. However, it is difficult to recognize which panel is shifted in which direction in a case in which the alignment marks are slightly shifted from each other.

The present invention is intended to provide a light adjustment device with which it is possible to more easily visually recognize the positional shift between stacked panels.

### SUMMARY

A light adjustment device according to an embodiment of the present disclosure includes a panel unit including a plurality of light adjustment panels stacked in a first direction, each light adjustment panel including a first substrate, a second substrate, and a plurality of alignment marks provided at at least one of the first substrate and the second substrate. When two light adjustment panels adjacent to each other in the first direction among the light adjustment panels are one light adjustment panel disposed on one side in the first direction and another light adjustment panel disposed on the other side in the first direction, any one of a first alignment mark and a second alignment mark surrounds the other alignment mark when viewed in the first direction, the first alignment mark being one of the alignment marks of the one light adjustment panel, the second alignment mark being one of the alignment marks of the other light adjustment panel and corresponding to the first alignment mark.

### BRIEF DESCRIPTION OF THE DRAWINGS

FIG. 1 is a plan view schematically illustrating a light adjustment device according to a first embodiment;

FIG. 2 is a sectional view schematically illustrating the light adjustment device according to the first embodiment;

FIG. 3 is a schematic diagram of a light adjustment panel according to the first embodiment when viewed from top;

FIG. 4 is a schematic diagram of a first substrate included in the light adjustment panel in FIG. 3 when viewed from top;

FIG. 5 is a schematic diagram of a second substrate included in the light adjustment panel in FIG. 3 when viewed from top;

FIG. 6 is a schematic diagram of the uppermost light adjustment panel included in the light adjustment device in FIG. 1 when viewed from top;

FIG. 7 is a schematic diagram of the second uppermost light adjustment panel included in the light adjustment device in FIG. 1 when viewed from top;

FIG. 8 is a schematic diagram of the third uppermost light adjustment panel included in the light adjustment device in FIG. 1 when viewed from top;

FIG. 9 is a schematic diagram of the fourth uppermost light adjustment panel included in the light adjustment device in FIG. 1 when viewed from top;

FIG. 10 is a schematic sectional view taken along line X-X in FIG. 1;

FIG. 11 is an enlarged schematic diagram of alignment marks in FIG. 1;

FIG. 12 is a schematic diagram of a light adjustment panel according to a second embodiment when viewed from top;

FIG. 13 is an enlarged schematic diagram of alignment marks in FIG. 12 when placed over each other;

FIG. 14 is a schematic diagram of a light adjustment panel according to a third embodiment when viewed from top; and

FIG. 15 is an enlarged schematic diagram of alignment marks in FIG. 14 when placed over each other.

### DETAILED DESCRIPTION

Aspects (embodiments) of the present disclosure will be described below in detail with reference to the accompanying drawings. Contents described below in the embodiments do not limit the present disclosure. Components described below include those that could be easily thought of by the skilled person in the art and those identical in effect. Components described below may be combined as appropriate.

What is disclosed herein is merely exemplary, and any modification that could be easily thought of by the skilled person in the art as appropriate without departing from the gist of the disclosure is contained in the scope of the present disclosure. For clearer description, the drawings are schematically illustrated for the width, thickness, shape, and the like of each component as compared to an actual aspect in some cases, but the drawings are merely exemplary and do not limit interpretation of the present disclosure. In the present specification and drawings, any element same as that already described with reference to an already described drawing is denoted by the same reference sign, and detailed description thereof is omitted as appropriate in some cases.

In an XYZ coordinate system illustrated in the drawings, an X direction is the front-back direction, and an X1 side is opposite an X2 side. The X1 side is also referred to as a back side, and the X2 side is also referred to as a front side. A Y direction is the right-left direction, and a Y1 side is opposite a Y2 side. The Y1 side is also referred to as a left side, and the Y2 side is also referred to as a right side. A Z direction is the up-down direction (stacking direction). A Z1 side is opposite a Z2 side. The Z1 side is also referred to as an upper side, and the Z2 side is also referred to as a lower side. The Z direction is also referred to as a first direction. The Z2 side is one side in the first direction, and the Z1 side is the other side in the first direction. In a light adjustment device according to an embodiment, a light adjustment panel (liquid crystal cell) for p-wave polarized light and a light adjustment panel (liquid crystal cell) for s-wave polarized light are stacked and combined. Specifically, the light adjustment panel for p-wave polarized light and the light adjustment panel for s-wave polarized light, which is obtained by rotating the light adjustment panel for p-wave polarized light by 90° are alternately stacked.

### First Embodiment

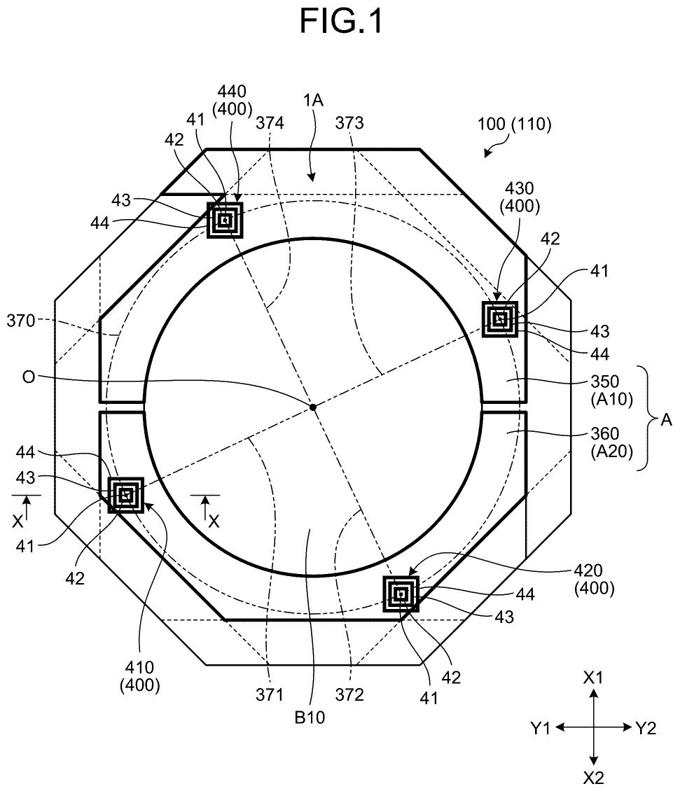

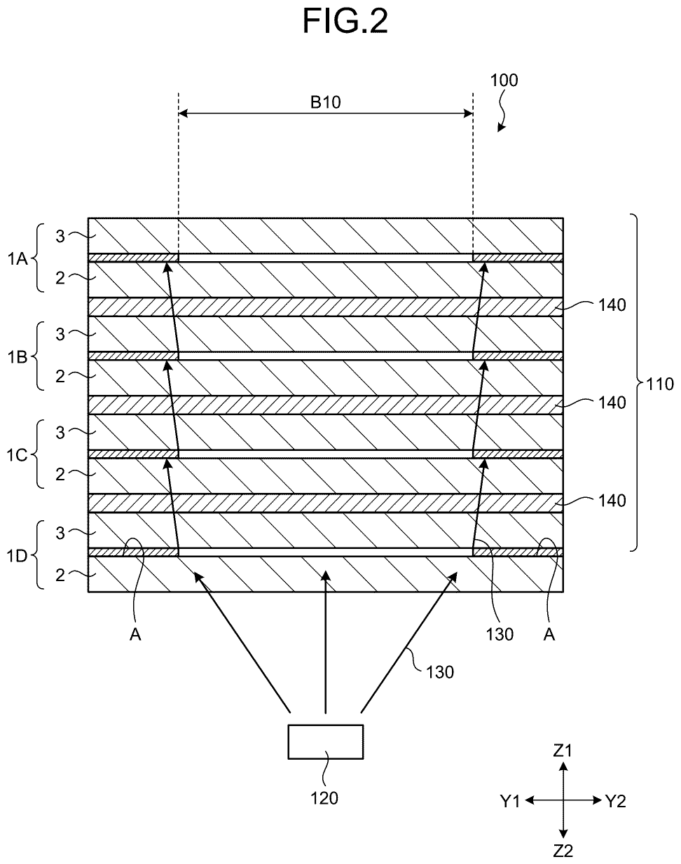

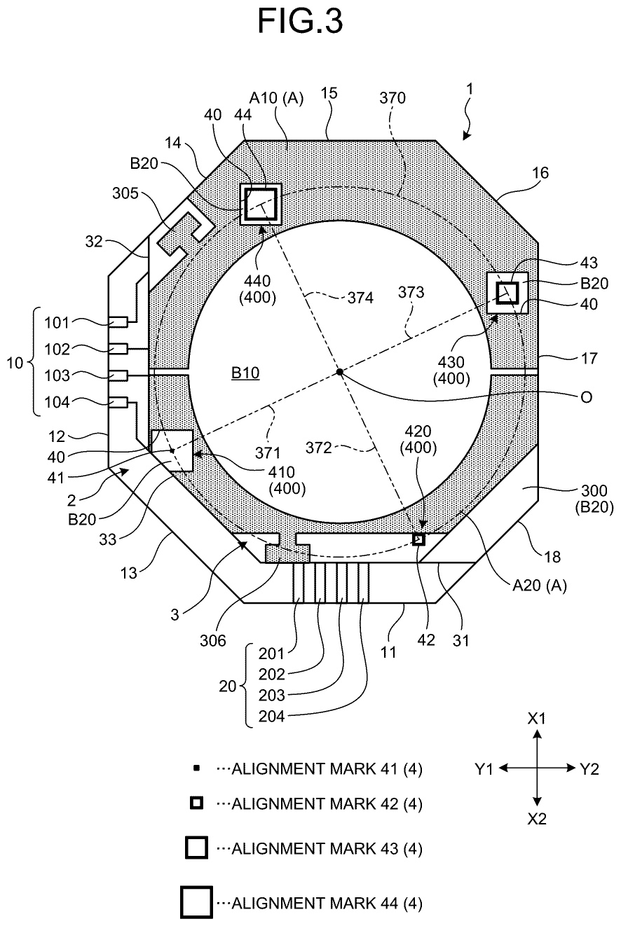

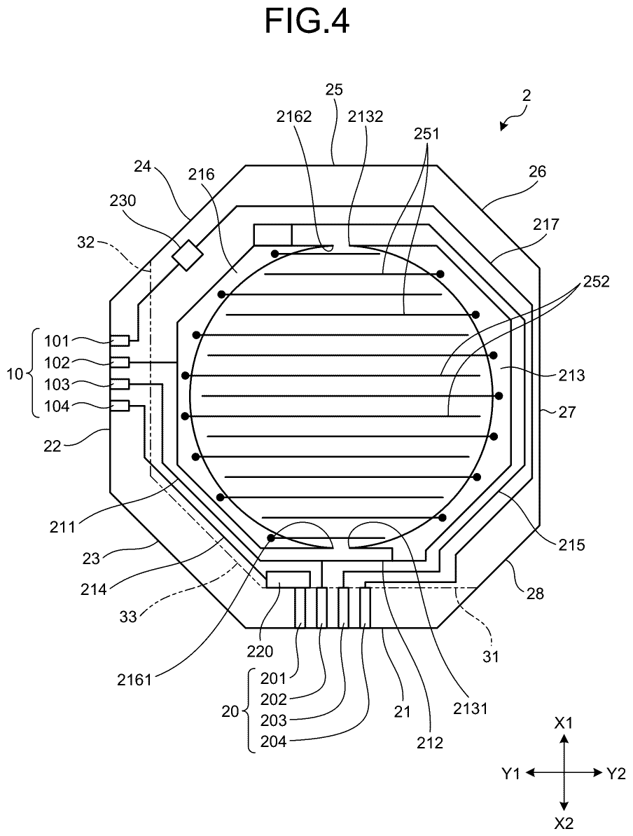

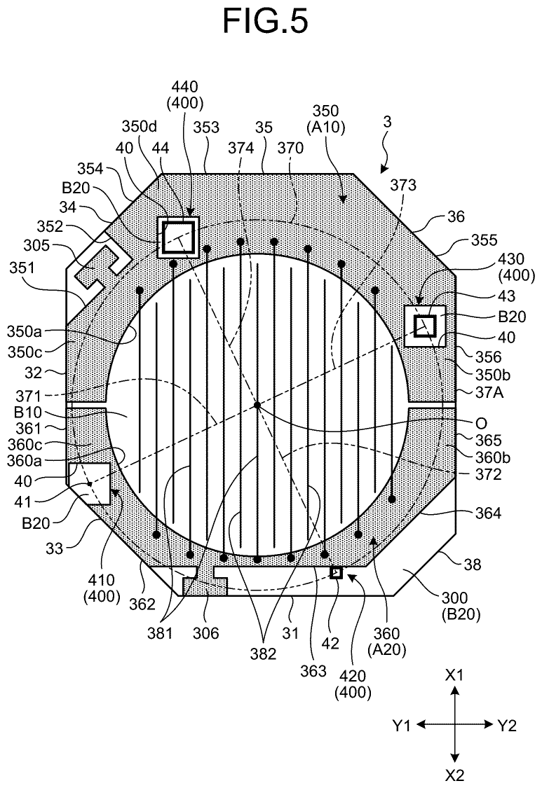

The following first describes a first embodiment. FIG. 1 is a plan view schematically illustrating a light adjustment device according to the first embodiment. FIG. 2 is a sectional view schematically illustrating the light adjustment device according to the first embodiment. FIG. 3 is a schematic diagram of a light adjustment panel according to the first embodiment when viewed from top. FIG. 4 is a schematic diagram of a first substrate included in the light adjustment panel in FIG. 3 when viewed from top. FIG. 5 is a schematic diagram of a second substrate included in the light adjustment panel in FIG. 3 when viewed from top.

A light adjustment device 100 according to the first embodiment includes four stacked light adjustment panels 1 each having an octagonal shape. Specific description is as follows. As illustrated in FIG. 1, a panel unit 110 included in the light adjustment device 100 has an outer edge in a regular octagonal shape in a plan view, a circular light-transmitting region (effective region) B10 is provided at the center of the panel unit 110, and a light-shielding region (frame region) A is provided on the outer peripheral side of the light-transmitting region B10. The light-transmitting region B10 is a circular region irradiated with light from a light source. The light-shielding region A includes a first light-shielding region A10 and a second light-shielding region A20.

As illustrated in FIG. 1, positional shift check portions 400 are disposed at four places on the outer peripheral side of the light-transmitting region B10 in the panel unit 110. Specifically, positional shift check portions 410, 420, 430, and 440 are positioned on the circumference of a circle 370 centered at a center O of the circular light-transmitting region B10. The circle 370 passes through the center of each positional shift check portion 400. The circle 370 has radii 371, 372, 373, and 374. More specifically, the radius 371 connects the center of the positional shift check portion 410 and the center O. The radius 372 connects the center of the positional shift check portion 420 and the center O. The radius 373 connects the center of the positional shift check portion 430 and the center O. The radius 374 connects the center of the positional shift check portion 440 and the center O. In each positional shift check portion 400, four alignment marks 4 are disposed from the center side toward the outside. More specifically, alignment marks 41, 42, 43, and 44 are disposed from the center side toward the outside. The alignment marks 4 will be described later in detail.

As illustrated in FIG. 1, the positional shift check portions 410, 420, 430, and 440 are arranged at equal intervals on the circumference of the circle 370. Specifically, central angles each sandwiched between radii adjacent to each other in the circumferential direction are all 90°. More specifically, the central angle between the radii 371 and 372 is 90°. The central angle between the radii 372 and 373 is 90°. The central angle between the radii 373 and 374 is 90°. The central angle between the radii 374 and 371 is 90°. In FIG. 1, the uppermost light adjustment panel among the stacked light adjustment panels 1 is a light adjustment panel 1A illustrated in FIG. 2, and thus only the outline of the light-shielding region A of the light adjustment panel 1A is illustrated with bold solid lines.

As illustrated in FIG. 2, the light adjustment device 100 includes the panel unit 110 and a light source 120. The light source 120 is, for example, a light emitting diode (LED). Light 130 emitted from the light source 120 is shielded by the light-shielding region A and travels upward through the light-transmitting region B10.

As illustrated in FIG. 2, the four light adjustment panels 1 are stacked in the panel unit 110. Each light adjustment panel 1 includes a first substrate 2 and a second substrate 3. The four light adjustment panels 1 include the light adjustment panel 1A, a light adjustment panel 1B, a light adjustment panel 1C, and a light adjustment panel 1D. The light adjustment panel 1A is positioned uppermost (closest to the Z1 side). The light adjustment panel 1B is positioned second uppermost. The light adjustment panel 1C is positioned third uppermost. The light adjustment panel 1D is positioned fourth uppermost. In other words, the light adjustment panel 1D is positioned lowermost. Light adjustment panels 1 vertically adjacent to each other are joined together through a translucent bonding agent 140. The translucent bonding agent 140 may be, for example, an optical clear adhesive (OCA).

As illustrated in FIG. 3, each light adjustment panel 1 has an octagonal shape in a plan view. The light adjustment panel 1 has a first side 11, a second side 12, a third side 13, a fourth side 14, a fifth side 15, a sixth side 16, a seventh side 17, and an eighth side 18. The light adjustment panel 1 includes two terminal groups (terminal groups 10 and 20). The terminal group 10 is provided at an edge portion of the second side 12, and a terminal group 20 is provided at an edge portion of the first side 11. The light adjustment panel 1 includes the translucent first substrate 2 and the translucent second substrate 3 disposed on the upper side of the first substrate 2. The first substrate 2 will be described below.

As illustrated in FIG. 4, in the present embodiment, the first substrate 2 has an octagonal shape and has a first side 21, a second side 22, a third side 23, a fourth side 24, a fifth side 25, a sixth side 26, a seventh side 27, and an eighth side 28. As illustrated in FIG. 4, the first substrate 2 is provided with wires, liquid crystal drive electrodes, and coupling portions. A coupling portion 220 of the first substrate 2 and a coupling portion 306 (refer to FIG. 5) of the second substrate 3 are electrically coupled to each other through a conductive pillar (not illustrated) through which conduction is possible. Similarly, a coupling portion 230 of the first substrate 2 and a coupling portion 305 (refer to FIG. 5) of the second substrate 3 are electrically coupled to each other through a conductive pillar (not illustrated) through which conduction is possible.

As illustrated in FIG. 4, the terminal group 10 includes a first terminal 101, a second terminal 102, a third terminal 103, and a fourth terminal 104. The first terminal 101, the second terminal 102, the third terminal 103, and the fourth terminal 104 are arranged in the X direction.

The terminal group 20 includes a fifth terminal 201, a sixth terminal 202, a seventh terminal 203, and an eighth terminal 204. The fifth terminal 201, the sixth terminal 202, the seventh terminal 203, and the eighth terminal 204 are arranged in the Y direction.

As illustrated in FIG. 4, a pair of semicircular wires 216 and 213 are disposed facing each other at a central part of the first substrate 2. The wire 216 is positioned on the Y1 side, and the wire 213 is positioned on the Y2 side. The wire 216 extends from an end 2161 to an end 2162. The wire 213 extends from an end 2131 to an end 2132. Edges of the wires 216 and 213 on the inner peripheral side have circular arc shapes, and the circle of the light-transmitting region B10 (refer to FIG. 3) is formed by the edge of the wire 216 on the inner peripheral side and the edge of 213 on the inner peripheral side.

The first terminal 101 and the eighth terminal 204 are coupled to each other through a wire 217. The coupling portion 230 is coupled to the wire 217. The second terminal 102 is coupled to the wire 216. The third terminal 103 and the sixth terminal 202 are coupled to each other through a wire 211. The fourth terminal 104 and the fifth terminal 201 are coupled to each other through a wire 214 and the coupling portion 220. The coupling portion 220 is coupled to the wire 214. The sixth terminal 202 is coupled to the wire 213 through a wire 212. The seventh terminal 203 is coupled to the wire 216 through a wire 215. The wire 215 is disposed on the inner side (the center side of the substrate) of the wire 217, and the wire 213 is disposed on the inner side of the wire 215.

A plurality of liquid crystal drive electrodes 251 are coupled to the wire 213. The liquid crystal drive electrodes 251 extend straight in the Y direction. The liquid crystal drive electrodes 251 are disposed at equal intervals in the X direction. A plurality of liquid crystal drive electrodes 252 are coupled to the wire 216. The liquid crystal drive electrodes 252 extend straight in the Y direction. The liquid crystal drive electrodes 252 are disposed at equal intervals in the X direction. The liquid crystal drive electrodes 251 and 252 are alternately arranged in the X direction.

As illustrated in FIG. 5, the second substrate 3 is provided with wires, liquid crystal drive electrodes, and coupling portions. In the present embodiment, as illustrated in FIG. 5, the second substrate 3 has an octagonal shape and has a first side 31, a second side 32, a third side 33, a fourth side 34, a fifth side 35, a sixth side 36, a seventh side 37, and an eighth side 38. When the second substrate 3 is placed on the upper side of the first substrate 2, the first side 31, the second side 32, and the third side 33 are positioned on the inner side of the first side 21, the second side 22, and the third side 23 of the first substrate 2 as illustrated with dashed and double-dotted lines in FIG. 4. More specifically, as illustrated in FIG. 4, the first side 31 is positioned on the X1 side of the first side 21, the second side 32 is positioned on the Y2 side of the second side 22, and the third side 33 is positioned on the X1 side and the Y2 side of the third side 23. Thus, in the light adjustment panel 1, an edge portion along the first side 21, an edge portion along the second side 22, and an edge portion along the third side 23 on the first substrate 2 are exposed as illustrated in FIGS. 3 and 4. Accordingly, the terminal groups 10 and 20 are exposed as well.

As illustrated in FIG. 5, the second substrate 3 is also provided with a first wire 350 and a second wire 360 formed along the outer shape of the second substrate 3 and the outer shape of the light-transmitting region B10. The first wire 350 and the second wire 360 serve as light-shielding layers and thus are larger than other wires in width.

As illustrated in FIG. 5, the first wire 350 and the second wire 360 are disposed around the light-transmitting region B10. The first wire 350 corresponds to the first light-shielding region A10, and the second wire 360 corresponds to the second light-shielding region A20. The first wire 350 is disposed on the X1 side on the second substrate 3, and the second wire 360 is disposed on the X2 side on the second substrate 3. The first wire 350 and the second wire 360 contain at least one of molybdenum (Mo), aluminum (l), nickel (Ni), and copper (Cu). Accordingly, the first wire 350 and the second wire 360 have light-shielding characteristics. The first wire 350 and the second wire 360 may be each formed as a solid film of a metal layer or formed in a fine mesh shape.

The outer edge of the first wire 350 includes edges 351, 352, 353, 354, 355, and 356. The inner edge of the first wire 350 includes an edge 350a. The edge 350a extends along a circle centered at the center O. An end portion of the first wire 350 on the X2 side includes an end portion 350b on the Y2 side and an end portion 350c on the Y1 side.

The outer edge of the second wire 360 includes edges 361, 362, 363, 364, and 365. The inner edge of the second wire 360 includes an edge 360a. The edge 360a extends along a circle centered at the center O. The edges 350a and 360a extend along circles centered at the center O and having the same radius. An end portion of the second wire 360 on the X1 side includes an end portion 360b on the Y2 side and an end portion 360c on the Y1 side. A non-light-shielding region B20 is provided at an edge portion 300 at the first side 31 and the eighth side 38 of the second substrate 3. The second wire 360 is disposed between the non-light-shielding region B20 and the light-transmitting region B10.

A plurality of liquid crystal drive electrodes 381 are coupled to the second wire 360. The liquid crystal drive electrodes 381 extend straight in the X direction. The liquid crystal drive electrodes 381 are disposed at equal intervals in the Y direction. A plurality of liquid crystal drive electrodes 382 are coupled to the first wire 350. The liquid crystal drive electrodes 382 extend straight in the X direction. The liquid crystal drive electrodes 382 are disposed at equal intervals in the Y direction. The liquid crystal drive electrodes 381 and 382 are alternately arranged in the Y direction.

More specifically, the positional shift check portions 400 described above with reference to FIG. 1 are provided on the second substrate 3 as illustrated in FIG. 5. The alignment marks 4 are, for example, metal patterns. The alignment marks 4 are made of, for example, the same material as the first wire 350 and the second wire 360 and can be formed in the same process together with the first wire 350 and the second wire 360 but may be formed in a separate process. The following specifically describes the positional shift check portions 400 and the alignment marks 4.

As illustrated in FIGS. 3 and 5, the positional shift check portion 410 is provided at the end portion 360c of the second wire 360. A non-light-shielding region B20 having an outer edge 40 in a square shape is provided in the positional shift check portion 410. The alignment mark 41 is provided at the center of the non-light-shielding region B20. The alignment mark 41 has a small square shape.

The positional shift check portion 420 is provided at the edge portion 300 of the second substrate 3. The alignment mark 42 is provided in the positional shift check portion 420. The alignment mark 42 has a square annular shape.

The positional shift check portion 430 is provided at the end portion 350b of the first wire 350. A non-light-shielding region B20 having an outer edge 40 in a square shape is provided at the positional shift check portion 430. The alignment mark 43 is provided at the center of the non-light-shielding region B20. The alignment mark 43 has a square annular shape.

The positional shift check portion 440 is provided at a corner 350d of the first wire 350. The corner 350d is a site surrounded by the edges 353, 354, 352, and 350a. A non-light-shielding region B20 having an outer edge 40 in a square shape is provided at the positional shift check portion 440. The alignment mark 44 is provided at the center of the non-light-shielding region B20. The alignment mark 44 has a square annular shape.

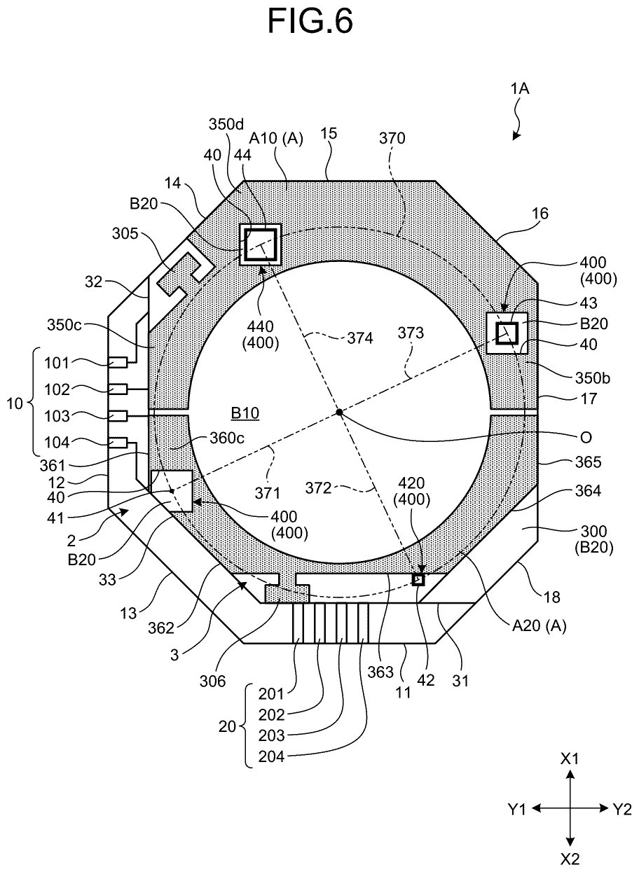

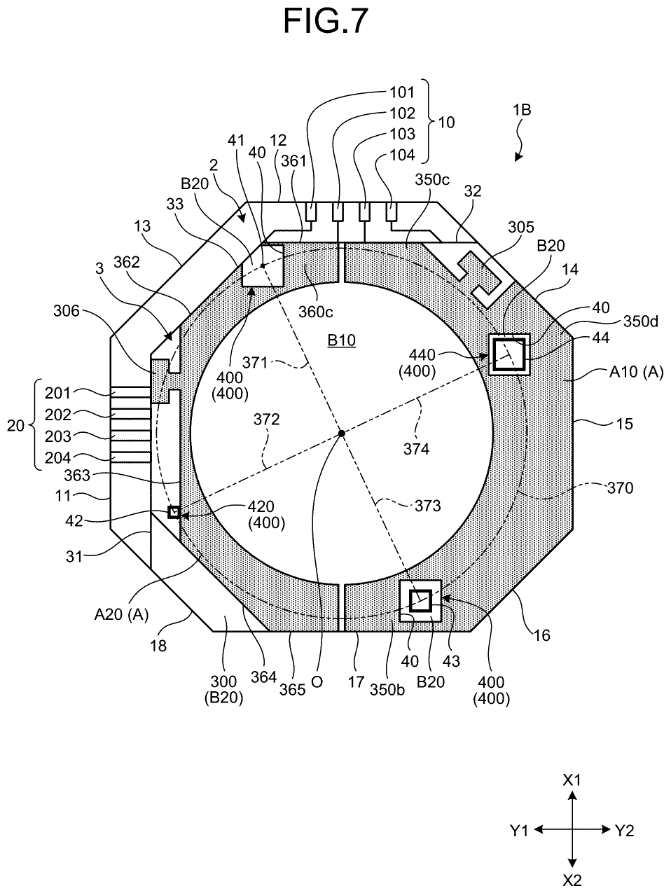

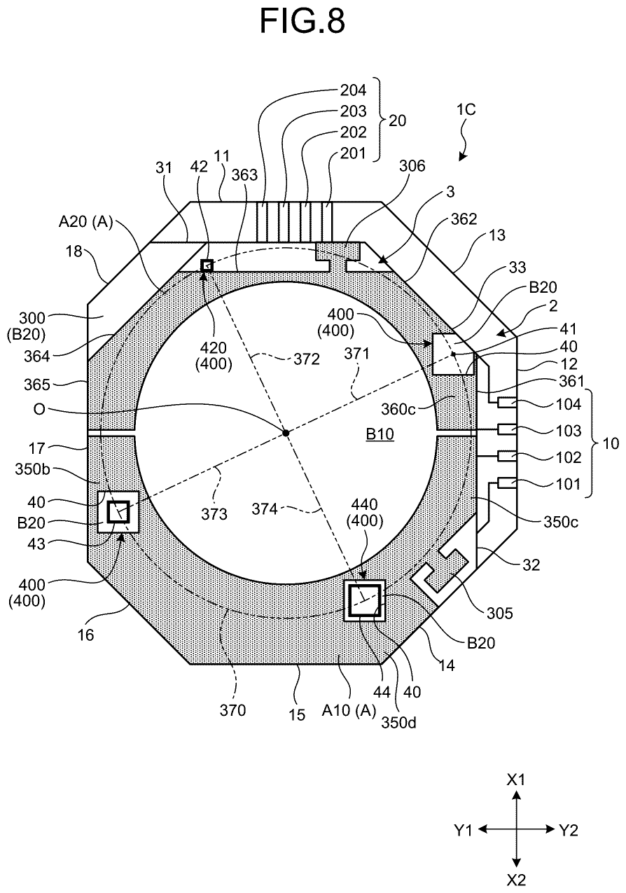

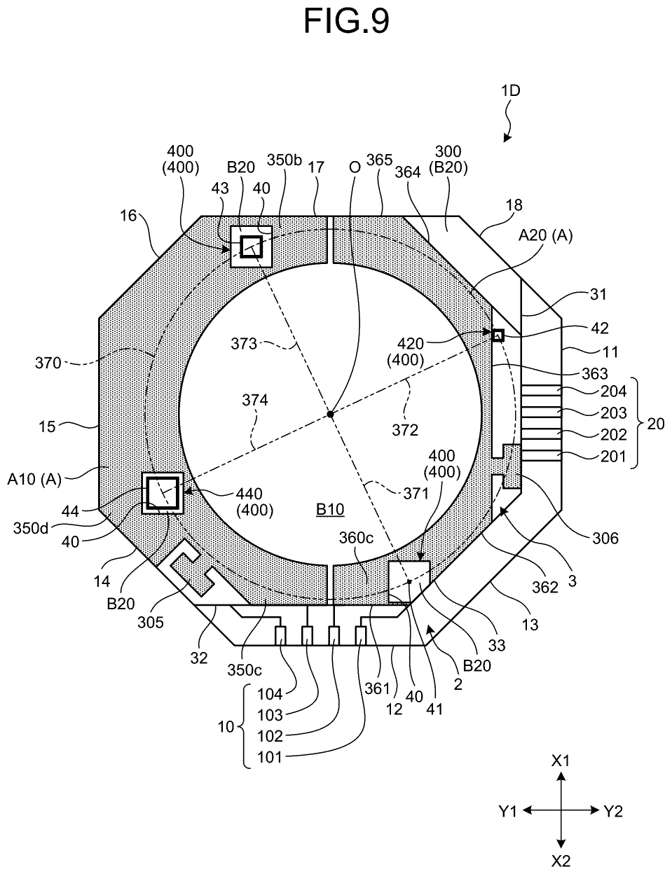

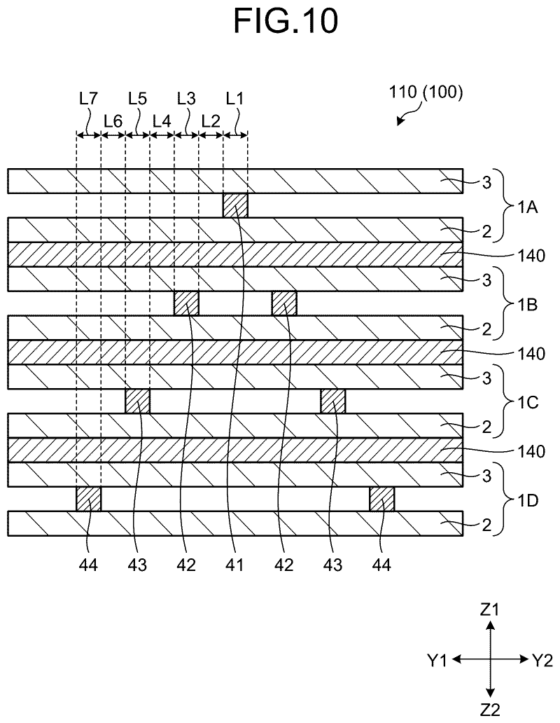

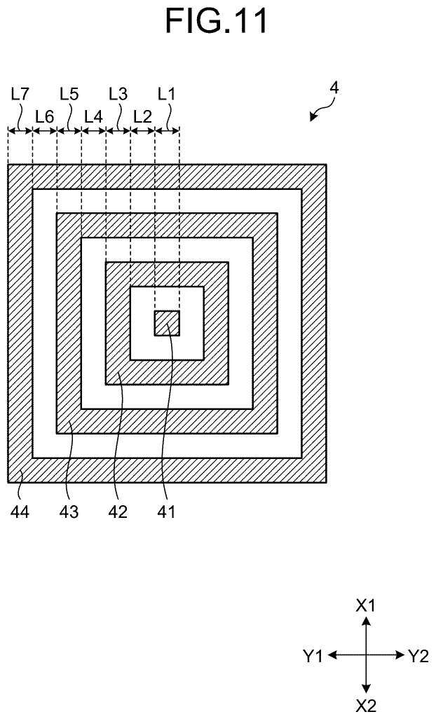

The following sequentially describes the four light adjustment panels 1 included in the panel unit 110. FIG. 6 is a schematic diagram of the uppermost light adjustment panel included in the light adjustment device in FIG. 1 when viewed from top. FIG. 7 is a schematic diagram of the second uppermost light adjustment panel included in the light adjustment device in FIG. 1 when viewed from top. FIG. 8 is a schematic diagram of the third uppermost light adjustment panel included in the light adjustment device in FIG. 1 when viewed from top. FIG. 9 is a schematic diagram of the fourth uppermost light adjustment panel included in the light adjustment device in FIG. 1 when viewed from top. FIG. 10 is a schematic sectional view taken along line X-X in FIG. 1. FIG. 11 is an enlarged schematic diagram of alignment marks in FIG. 1.

As illustrated in FIG. 6, the light adjustment panel 1A positioned uppermost is the same as in FIG. 3. As illustrated in FIG. 7, when viewed from top, the second uppermost light adjustment panel 1B is in the same state as the light adjustment panel 1A being rotated by 90° in the clockwise direction with respect to the center O. As illustrated in FIG. 8, when viewed from top, the third uppermost light adjustment panel 1C is in the same state as the light adjustment panel 1B being rotated by 90° in the clockwise direction with respect to the center O. As illustrated in FIG. 9, when viewed from top, the fourth uppermost light adjustment panel 1D is in the same state as the light adjustment panel 1C being rotated by 90° in the clockwise direction with respect to the center O.

When the four light adjustment panels 1A, 1B, 1C, and 1D are placed over each other, the alignment marks of the light adjustment panel 1C are disposed on the upper side of the alignment marks of the light adjustment panel 1D, the alignment marks of the light adjustment panel 1B are disposed on the upper side of the alignment marks of the light adjustment panel 1C, and the alignment marks of the light adjustment panel 1A are disposed on the upper side of the alignment marks of the light adjustment panel 1B.

More specifically, for example, at the positional shift check portion 410 in FIG. 1, the alignment mark 43 of the light adjustment panel 1C is disposed on the upper side of the alignment mark 44 of the light adjustment panel 1D, the alignment mark 42 of the light adjustment panel 1B is disposed on the upper side of the alignment mark 43 of the light adjustment panel 1C, and the alignment mark 41 of the light adjustment panel 1A is disposed on the upper side of the alignment mark 42 of the light adjustment panel 1B as illustrated in FIG. 10.

Thus, when the positional shift check portion 410 in FIG. 1 is viewed from top, the four alignment marks 4 having square outer edges can be visually recognized as illustrated in FIG. 11. The alignment mark 41 is disposed at the center. The alignment mark 41 has a square shape in a plan view. The alignment mark 42 is formed in a square annular shape. The alignment mark 42 is disposed outside the alignment mark 41 and surrounds the alignment mark 41. The alignment mark 43 is formed in a square annular shape. The alignment mark 43 is disposed outside the alignment mark 42 and surrounds the alignment mark 42. The alignment mark 44 is formed in a square annular shape. The alignment mark 44 is disposed outside the alignment mark 43 and surrounds the alignment mark 43.

Consider two alignment marks (for example, the alignment marks 41 and 42) adjacent to each other in the circumferential direction with respect to the center O of the circle 370. The alignment mark 42 is positioned on one side in the circumferential direction, and the alignment mark 41 is positioned on the other side in the circumferential direction. When the alignment marks 42 and 41 are placed over each other, the annular shape of the alignment mark 42 surrounds the alignment mark 41. Similarly, among two alignment marks 4 adjacent to each other in the circumferential direction, such as the alignment marks 42 and 43 or the alignment marks 43 and 44, an alignment mark 4 on one side in the circumferential direction has a square shape surrounding the other alignment mark 4 on the other side in the circumferential direction.

The four alignment marks 41, 42, 43, and 44 positioned further in the anticlockwise direction with respect to the center O of the circle 370 have larger outer edges.

As illustrated FIG. 10, two light adjustment panels 1 adjacent to each other in the Z direction among the light adjustment panels 1 are referred to as one light adjustment panel (for example, the light adjustment panel 1B) disposed on the Z2 side (one side in the first direction) and the other light adjustment panel (for example, the light adjustment panel 1A) disposed on the Z1 side (the other side in the first direction). The alignment mark 42 (first alignment mark) of the one light adjustment panel (light adjustment panel 1B) surrounds the alignment mark 41 (second alignment mark) of the other light adjustment panel (light adjustment panel 1A) when viewed in the Z direction. This is the same for the light adjustment panels 1B and 1C and the light adjustment panels 1C and 1D.

Specifically, in a case in which the first alignment mark is a predetermined alignment mark 4 of the light adjustment panel 1C illustrated in FIG. 10 and the second alignment mark is a predetermined alignment mark 4 of the light adjustment panel 1B, one of the first and second alignment marks surrounds the other alignment mark when viewed in the Z direction. More specifically, the first alignment mark of the light adjustment panel 1C surrounds the second alignment mark of the light adjustment panel 1B when viewed in the Z direction.

In a case in which the first alignment mark is a predetermined alignment mark 4 of the light adjustment panel 1D and the second alignment mark is a predetermined alignment mark 4 of the light adjustment panel 1C, one of the first and second alignment marks surrounds the other alignment mark when viewed in the Z direction. More specifically, the first alignment mark of the light adjustment panel 1D surrounds the second alignment mark of the light adjustment panel 1C when viewed in the Z direction.

As illustrated in FIG. 10, the lengths of the alignment mark 41 in the X and Y directions are a distance L1. The distances between the outer edge of the alignment mark 41 and the inner edge of the alignment mark 42 in the X and Y directions are a distance L2. The width of the alignment mark 42 is a distance L3. The distances between the outer edge of the alignment mark 42 and the inner edge of the alignment mark 43 in the X and Y directions are a distance L4. The width of the alignment mark 43 is a distance L5. The distances between the outer edge of the alignment mark 43 and the inner edge of the alignment mark 44 in the X and Y directions are a distance L6. The width of the alignment mark 44 is a distance L7. The distances L1, L2, L3, L4, L5, L6, and L7 have equal lengths, for example, in the present embodiment, but may have different lengths instead of being set to equal lengths.

As described above, the light adjustment device 100 according to the first embodiment includes the panel unit 110 including the light adjustment panels 1 stacked in the Z direction (first direction), each light adjustment panel 1 including the first substrate 2 and the second substrate 3. When two light adjustment panels 1 adjacent to each other in the Z direction among the light adjustment panels 1 are one light adjustment panel (for example, the light adjustment panel 1B) disposed on the Z2 side (one side in the first direction) and the other light adjustment panel (for example, the light adjustment panel 1A) disposed on the Z1 side (the other side in the first direction), the alignment mark 42 (first alignment mark) of the one light adjustment panel surrounds the alignment mark 41 (second alignment mark) of the other light adjustment panel.

As described above, in the light adjustment device, a light adjustment panel for p-wave polarized light and a light adjustment panel for s-wave polarized light, which is obtained by rotating the light adjustment panel for p-wave polarized light by 90° are alternately stacked. Thus, it is required to reduce the positional shift between the light adjustment panels. In JP-A-2019-70734, all alignment marks have the same size and the same rectangular shape. Thus, in a case in which the alignment marks are slightly shifted from each other when the light adjustment device is viewed from top, it is potentially difficult to recognize which panel is shifted in which direction.

However, in the present embodiment, among two light adjustment panels (for example, the light adjustment panels 1A and 1B) adjacent to each other in the Z direction, the alignment mark 42 of one light adjustment panel (light adjustment panel 1B) surrounds the alignment mark 41 of the other light adjustment panel (light adjustment panel 1A) when viewed in the Z direction. Thus, when all light adjustment panels 1 are placed over each other, it is easier to recognize which panel is shifted in which direction. In this manner, according to the present embodiment, the light adjustment device 100 with which it is possible to more easily visually recognize the positional shift between the stacked light adjustment panels 1 is obtained.

The alignment marks 4 are disposed on the circumference of the circle 370 at equal intervals in the circumferential direction, the circle 370 having the center O at a central part of each light adjustment panel 1. Among two alignment marks (for example, the alignment marks 41 and 42) adjacent to each other in the circumferential direction, an alignment mark (for example, the alignment mark 42) on one side in the circumferential direction has an annular shape surrounding the other alignment mark (for example, the alignment mark 41) on the other side in the circumferential direction.

Thus, the light adjustment device 100 with which it is possible to more easily visually recognize the positional shift between stacked light adjustment panels 1 is obtained by preparing a plurality of identical light adjustment panels 1, placing the light adjustment panels 1 over each other in the Z direction in states rotationally separated from each other by a predetermined angle with respect to the center O, and appropriately adjusting the positional relation the alignment marks 41 and 42.

Moreover, since the outer edge of each alignment mark 4 has a square shape when viewed in the Z direction (first direction), it is possible to easily visually recognize whether the positional shift direction of each light adjustment panel 1 is the X direction or the Y direction.

### Second Embodiment

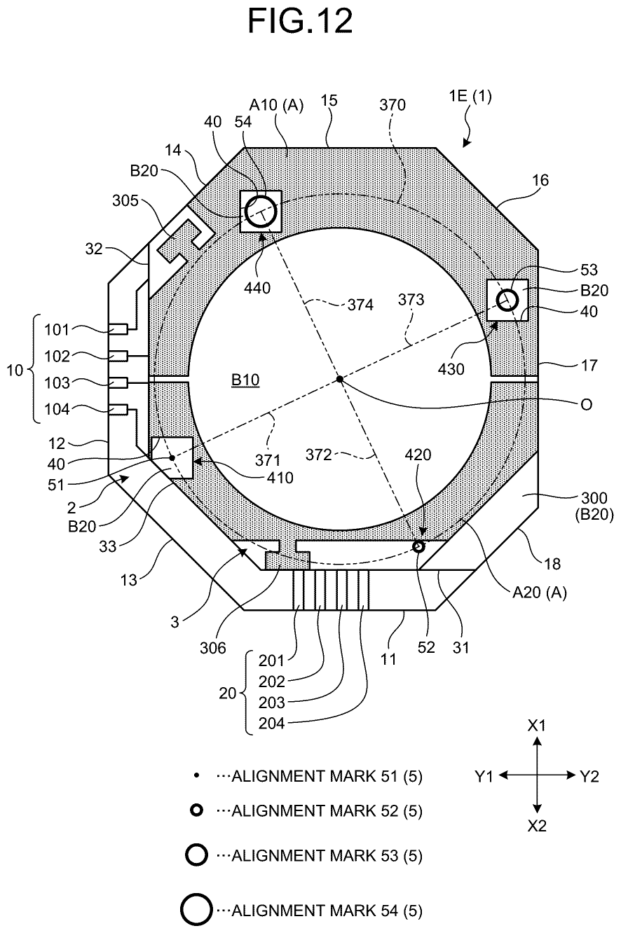

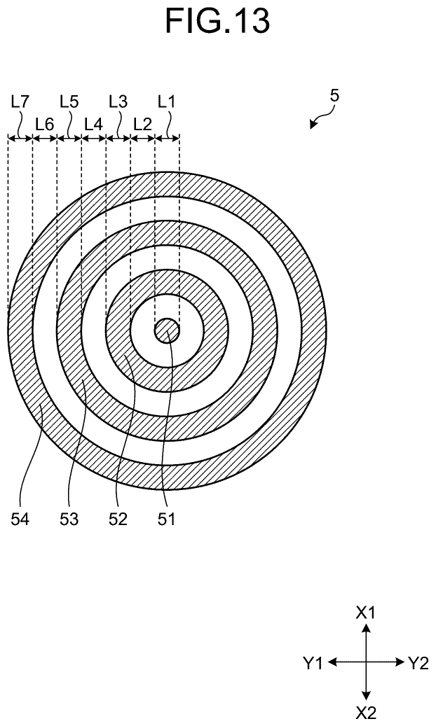

The following describes a second embodiment. FIG. 12 is a schematic diagram of a light adjustment panel according to the second embodiment when viewed from top. FIG. 13 is an enlarged schematic diagram of alignment marks in FIG. 12 when placed over each other. Each alignment mark 4 according to the first embodiment has an outer edge in a square shape. However, each alignment mark 5 according to the second embodiment has an outer edge in a circular shape.

As illustrated in FIG. 12, a non-light-shielding region B20 having an outer edge 40 in a square shape is provided at the positional shift check portion 410 provided in a light adjustment panel 1E according to the second embodiment. An alignment mark 51 is provided at the center of the non-light-shielding region B20. The alignment mark 51 has a small circular shape.

An alignment mark 52 is provided at the positional shift check portion 420. The alignment mark 52 has a circular annular shape.

A non-light-shielding region B20 having an outer edge 40 in a square shape is provided at the positional shift check portion 430. An alignment mark 53 is provided at the center of the non-light-shielding region B20. The alignment mark 53 has a circular annular shape.

A non-light-shielding region B20 having an outer edge 40 in a square shape is provided at the positional shift check portion 440. An alignment mark 54 is provided at the center of the non-light-shielding region B20. The alignment mark 54 has a circular annular shape.

When the positional shift check portion 410 is viewed from top, the four alignment marks 5 having circular outer edges can be visually recognized as illustrated in FIG. 13. The alignment mark 51 is disposed at the center. The alignment mark 51 has a circular shape in a plan view. The alignment mark 52 is formed in a circular annular shape. The alignment mark 52 is disposed outside the alignment mark 51 and surrounds the alignment mark 51. The alignment mark 53 is formed in a circular annular shape. The alignment mark 53 is disposed outside the alignment mark 52 and surrounds the alignment mark 52. The alignment mark 54 is formed in a circular annular shape. The alignment mark 54 is disposed outside the alignment mark 53 and surrounds the alignment mark 53.

As illustrated in FIG. 13, the diameter of the alignment mark 51 is a distance L11. The distance between the outer edge of the alignment mark 51 and the inner edge of the alignment mark 52 is a distance L12. The width of the alignment mark 52 is a distance L13. The distance between the outer edge of the alignment mark 52 and the inner edge of the alignment mark 53 is a distance L14. The width of the alignment mark 53 is a distance L15. The distance between the outer edge of the alignment mark 53 and the inner edge of the alignment mark 53 is a distance L16. The width of an alignment mark 55 is a distance L17. The outer edges of the alignment marks 51, 52, 53, and 54 are concentric circles centered at the center O. The distances L11, L12, L13, L14, L15, L16, and L17 have equal lengths, for example, in the present embodiment, but may have different lengths instead of being set to equal lengths.

As described above, in the second embodiment, the outer edge of each alignment mark 5 has a circular shape when viewed in the Z direction (first direction). Among two light adjustment panels 1 adjacent to each other in the Z direction, the alignment mark 52 of one light adjustment panel surrounds the alignment mark 51 of the other light adjustment panel 1 when viewed in the Z direction. Thus, when all light adjustment panels 1 are placed over each other, it is easier to recognize which panel is shifted in which direction. More specifically, although it is difficult to visually recognize the square alignment marks 4, for example, with positional shift on the X1 side and the Y1 side, the circular alignment marks 5 can be easily visually recognized irrespective of shift in any direction along the radial direction with respect to the center of the alignment marks 5.

### Third Embodiment

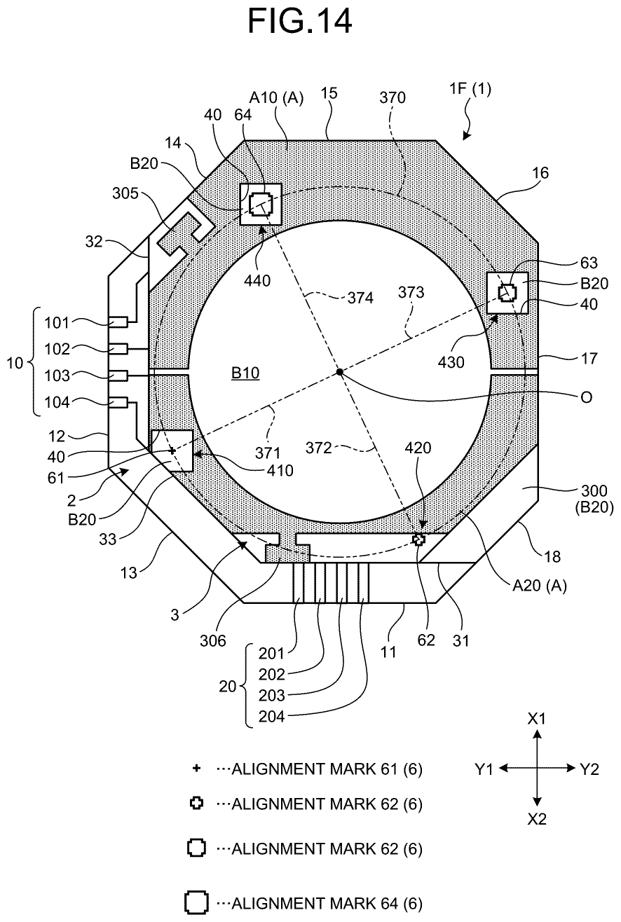

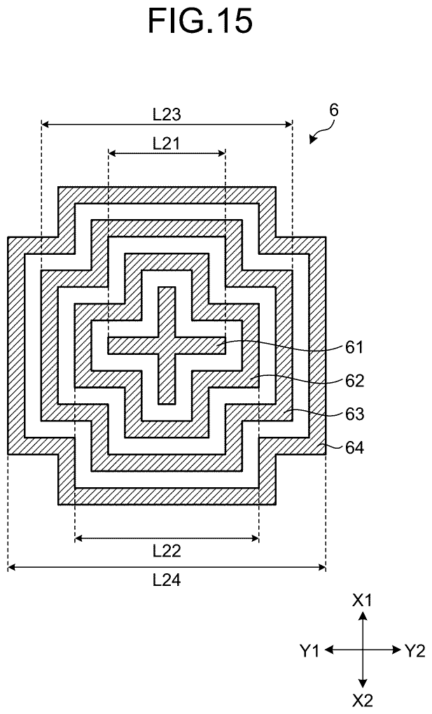

The following describes a third embodiment. FIG. 14 is a schematic diagram of a light adjustment panel according to the third embodiment when viewed from top. FIG. 15 is an enlarged schematic diagram of alignment marks in FIG. 14 when placed over each other. Each alignment mark 4 according to the first embodiment has an outer edge in a square shape. However, each alignment mark 6 according to the third embodiment has an outer edge in a cross shape.

As illustrated in FIG. 14, a non-light-shielding region B20 having an outer edge 40 in a square shape is provided at the positional shift check portion 410 provided in a light adjustment panel 1F according to the third embodiment. An alignment mark 61 is provided at the center of the non-light-shielding region B20. The alignment mark 61 has a small cross shape.

An alignment mark 62 is provided at the positional shift check portion 420. The alignment mark 62 has a cross annular shape.

A non-light-shielding region B20 having an outer edge 40 in a square shape is provided at the positional shift check portion 430. An alignment mark 63 is provided at the center of the non-light-shielding region B20. The alignment mark 63 has an outer edge in a cross annular shape.

A non-light-shielding region B20 having an outer edge 40 in a square shape is provided at the positional shift check portion 440. An alignment mark 64 is provided at the center of the non-light-shielding region B20. The alignment mark 64 has an outer edge in a cross annular shape.

When the positional shift check portion 410 is viewed from top, the four alignment marks 6 having cross outer edges can be visually recognized as illustrated in FIG. 15. The alignment mark 61 is disposed at the center. The alignment mark 61 has a cross shape in a plan view. The alignment mark 62 is formed in an annular shape having a cross outer edge. The alignment mark 62 is disposed outside the alignment mark 61 and surrounds the alignment mark 61. The alignment mark 63 is formed in an annular shape having a cross outer edge. The alignment mark 63 is disposed outside the alignment mark 62 and surrounds the alignment mark 62. The alignment mark 64 is formed in an annular shape having a cross outer edge. The alignment mark 64 is disposed outside the alignment mark 63 and surrounds the alignment mark 63.

As illustrated in FIG. 15, the maximum lengths of the alignment mark 61 in the Y and X directions are a distance L21. The maximum lengths of the alignment mark 62 in the Y and X directions are a distance L22. The distance L22 is longer than the distance L21. The maximum lengths of the alignment mark 63 in the Y and X directions are a distance L23. The distance L23 is longer than the distance L22. The maximum lengths of the alignment mark 64 in the Y and X directions are a distance L24. The distance L24 is longer than the distance L23.

As described above, in the third embodiment, the outer edge of each alignment mark 6 has a cross annular shape when viewed in the Z direction (first direction). Among two light adjustment panels 1 adjacent to each other in the Z direction, an alignment mark 6 (for example, the alignment mark 62) of one light adjustment panel 1 surrounds an alignment mark 6 (for example, the alignment mark 61) of the other the light adjustment panel 1 when viewed in the Z direction. Thus, when all light adjustment panels 1 are placed over each other, it is easier to recognize which the light adjustment panel 1 is shifted in which direction.

What is claimed is:

1. A light adjustment device comprising a panel unit including a plurality of light adjustment panels stacked in a first direction, each light adjustment panel including a first substrate, a second substrate, and a plurality of alignment marks provided at at least one of the first substrate and the second substrate, wherein
when two light adjustment panels adjacent to each other in the first direction among the light adjustment panels are one light adjustment panel disposed on one side in the first direction and another light adjustment panel disposed on the other side in the first direction,
any one of a first alignment mark and a second alignment mark surrounds the other alignment mark when viewed in the first direction, the first alignment mark being one of the alignment marks of the one light adjustment panel, the second alignment mark being one of the alignment marks of the other light adjustment panel and corresponding to the first alignment mark.

2. The light adjustment device according to claim 1, wherein
the alignment marks of one of the light adjustment panels are disposed on a circumference of a circle at equal intervals in a circumferential direction, the circle being centered at a central part of the light adjustment panel, and
among two alignment marks adjacent to each other in the circumferential direction, an alignment mark on one side in the circumferential direction has an annular shape surrounding the other alignment mark on the other side in the circumferential direction.

3. The light adjustment device according to claim 1, wherein each alignment mark has an outer edge in a square shape when viewed in the first direction.

4. The light adjustment device according to claim 1, wherein each alignment mark has an outer edge in a circular shape when viewed in the first direction.

5. The light adjustment device according to claim 1, wherein each alignment mark has an outer edge in a cross shape when viewed in the first direction.
